(19) United States
(12) Patent Application Publication
(10) Pub. No.: US 2011/0296169 A1
(43) Pub. Date: Dec. 1, 2011

(54) FACILITATING SECURE COMMUNICATION BETWEEN UTILITY DEVICES

(76) Inventor: CHARLES GRAHAM PALMER, Baslow (GB)

(21) Appl. No.: 13/062,645

(22) PCT Filed: Sep. 4, 2009
(86) PCT No.: PCT/IB2009/006768

§ 371 Date: Aug. 19, 2011

(30) Foreign Application Priority Data
Sep. 5, 2008 (GB) 0816319.8
Nov. 14, 2008 (GB) 0820888.6
Apr. 16, 2009 (GB) 0906527.7

(51) Int. Cl. H04L 9/00

(52) U.S. Cl. 713/153

(57) ABSTRACT

Communication is facilitated between a plurality of servers (101,102,103) and a plurality of local devices (204,206,207,208,210). An apparatus comprises a first network interface for communicating with the servers, a second network interface for communicating with the local devices, and a microcontroller having a processor, memory, a cryptographic engine for carrying out cryptographic calculations, and a tamper-resistance element configured to resist tampering with the apparatus. A plurality of programs, each comprising instructions and data, are stored in the memory. The processor is configured to, for a first local device, identify a first program which is associated with the first local device, and using the first program, provide a secure communications channel between the first local device and a first server. The processor is unable to accept commands from any other of the programs to access or change the first program, and the processor is unable to route messages over the secure communications channel that are not from or to the first local device and the first server.

### BACKGROUND OF THE INVENTION

1. Field of the Invention

The present invention relates to apparatus for facilitating secure communication between local devices and remote servers.

2. Description of the Related Art

Increasingly, suppliers of utilities such as gas, electricity and water are installing “smart meters” in the homes and places of business of consumers. These smart meters include a communications interface that allows the utility supplier to monitor usage remotely. However, such a smart meter cannot be used for anything else because of the danger of tampering by the user or a third party.

### BRIEF SUMMARY OF THE INVENTION

According to an aspect of the present invention, there is therefore provided, apparatus for facilitating communication between a plurality of servers and a plurality of local devices, comprising a first network interface for communicating with said servers, a second network interface for communicating with said local devices, and a microcontroller having a processor, memory, a cryptographic engine for carrying out cryptographic calculations, and a tamper-resistance element configured to resist tampering with said apparatus, wherein a plurality of programs, each comprising instructions and data, are stored in said memory, and said processor is configured to: for a first local device, identify a first program which is associated with said device, and using said first program, provide a secure communications channel between said first local device and a first server, wherein said processor is unable to accept commands from any other of said programs to access or change said first program, and said processor is unable to route messages over said secure communications channel that are not from or to said first local device and said first server.

### BRIEF DESCRIPTION OF THE SEVERAL VIEWS OF THE DRAWINGS

FIG. 1 illustrates an environment in which embodiments of the present invention may be used;

FIG. 2 illustrates a home shown in FIG. 1;

FIG. 3 is a block diagram of a meter shown in FIG. 2 that embodies the invention;

FIG. 4 is a block diagram of a secure microcontroller shown in FIG. 3;

FIG. 5 illustrates the contents of the memory shown in FIG. 4;

FIG. 6 details applets shown in FIG. 5;

FIG. 7 details an applet shown in FIG. 6;

FIG. 8 details a security domain applet shown in FIG. 6;

FIG. 9 details operational steps for the meter shown in FIG. 3;

FIG. 10 illustrates secure communication between local devices shown in FIG. 2 and remote servers shown in FIG. 1;

FIG. 11 is an alternative embodiment of a smart meter embodying the invention;

FIG. 12 is a further alternative embodiment of a smart meter embodying the invention;

FIG. 13 illustrates a mesh network comprising the smart meters shown in FIGS. 3, 12 and 13; and

FIG. 14 is a further embodiment of a communications device embodying the invention.

### DETAILED DESCRIPTION OF THE PREFERRED EMBODIMENTS

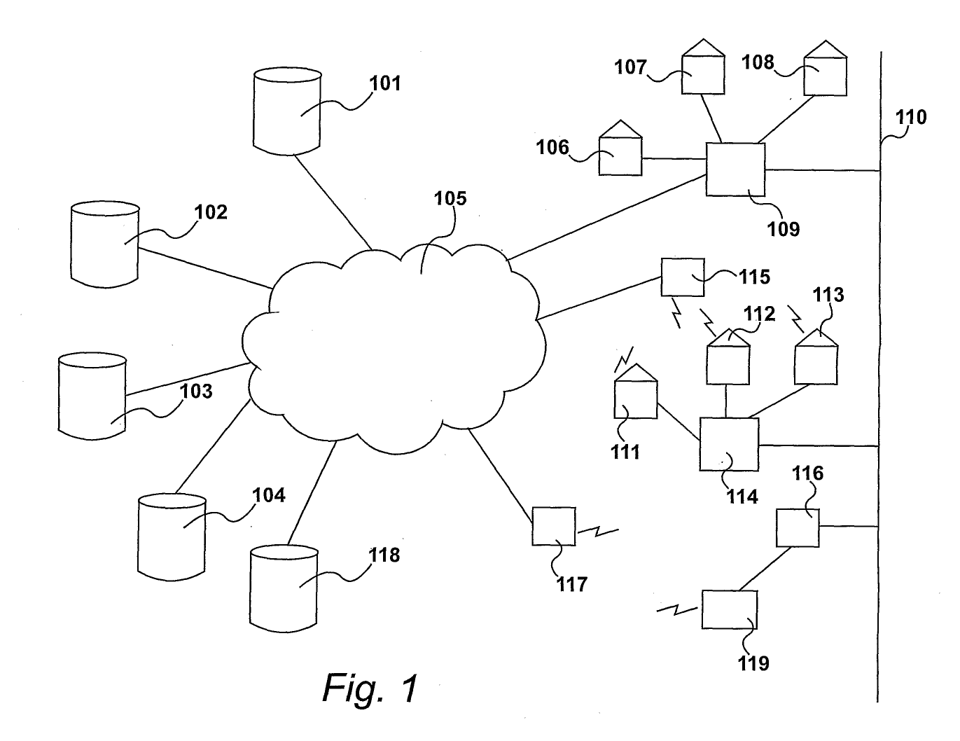

### FIG. 1

FIG. 1 illustrates an environment in which embodiments of the invention herein described may be used. Servers 101, 102, 103, 104 and 118 are connected to the Internet 105. Server 101 is a server of an electricity supplier, server 102 is a server of a gas supplier, server 103 is a server of a telecare provider, and server 104 is a server of a supermarket chain.

Various homes and places of business are also connected to Internet 105. Homes 106, 107 and 108 are connected via a mains power line to substation 109. From this they draw their power from the national grid 110. Substation 109 also comprises a concentrator which receives signals from the homes sent down the power lines and forwards them in a suitable format to Internet 105. Each substation can typically serve one hundred to two hundred properties, although only three are shown here.

Homes 111, 112 and 113 are connected to substation 114 via which they draw electricity from the national grid 110. However, these homes do not communicate to the Internet via the substation. Rather they communicate wirelessly with a local concentrator 115 using a wireless mesh network.

Factory 119 draws power via substation 116. However it does not use substation 116 for communications. Rather it communicates via a GPRS modem with a GPRS gateway 117, via which it accesses Internet 105.

Many other ways for homes and places of business to connect to the Internet are available. For example, WiMax radio, Ethernet, a telephone modem, ASDL broadband or any other suitable method could be used.

In the network shown in FIG. 1, it is possible for devices within homes or places of business to communicate securely with servers 101 to 104. Alternatives to the Internet 105 include a mobile telephone network, a Virtual Private Network, or another network suitable for communication between the devices and servers.

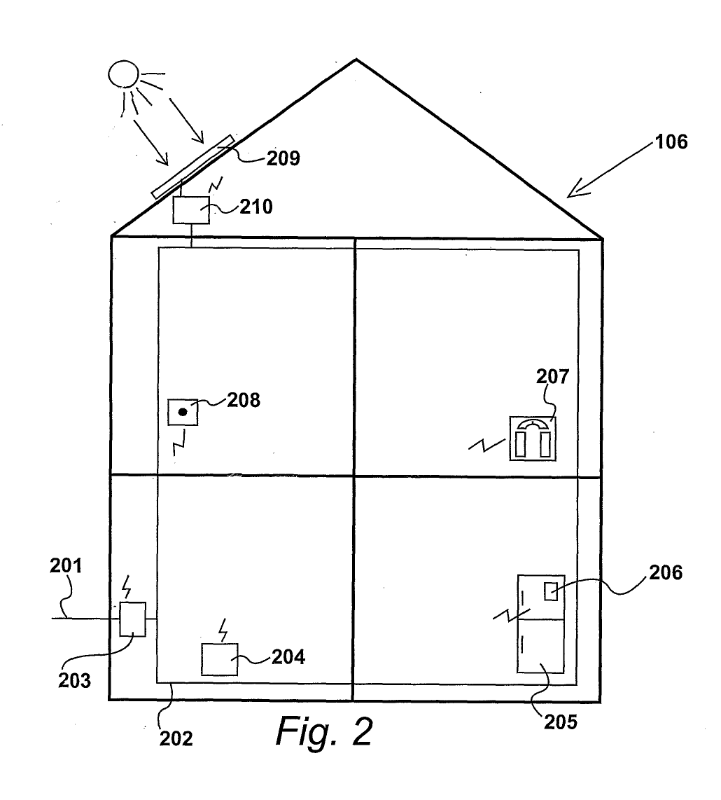

### FIG. 2

Home 106 comprises several devices that communicate with remote servers. Electricity is provided to home 106 via mains power line 201, and premises electricity wiring 202 provides power to devices in the home. Smart meter 203 monitors the electricity usage and communicates with electricity supplier server 101 to provide details of usage. Smart meter 203 includes a wireless communications interface for the purpose of communicating with other devices in the home. A portable wireless user interface 206 displays electricity usage to the user, and is in this example attached magnetically to a refrigerator 205.

Other devices in the home also communicate with meter 203. Gas meter 204 monitors gas usage, scales 207 are used to measure the weight of a user, panic button 208 is used to raise an alarm if necessary, and solar array 209 and transformer 210 provide additional power to the house that can be exported to the national grid 110 if necessary. Each of these devices communicates wirelessly with meter 203, although communication via the wiring 202 would also be possible for those devices that are connected to it.

Each of these devices communicates with a associated remote server. Thus, gas meter 204 communicates with gas supplier server 102, scales 207 and panic button 208 communicate with telecare provider server 103, and transformer 210 communicates with electricity supplier server 101. All of this communication is facilitated by meter 203 and routed via mains power 201, the concentrator at substation 109 and Internet 105.

Thus a single device within the home which must of necessity be installed, such as an electricity meter, may be used to enable communication between many household devices and associated servers. However, it is extremely important that each communication link is separate and secure, that meter 203 cannot be tampered with by a user, and that data produced by, received by or stored by any of the devices is not accessible by any third party, including the makers of the other devices in the home and owners of the servers which are not associated with the communicating devices.

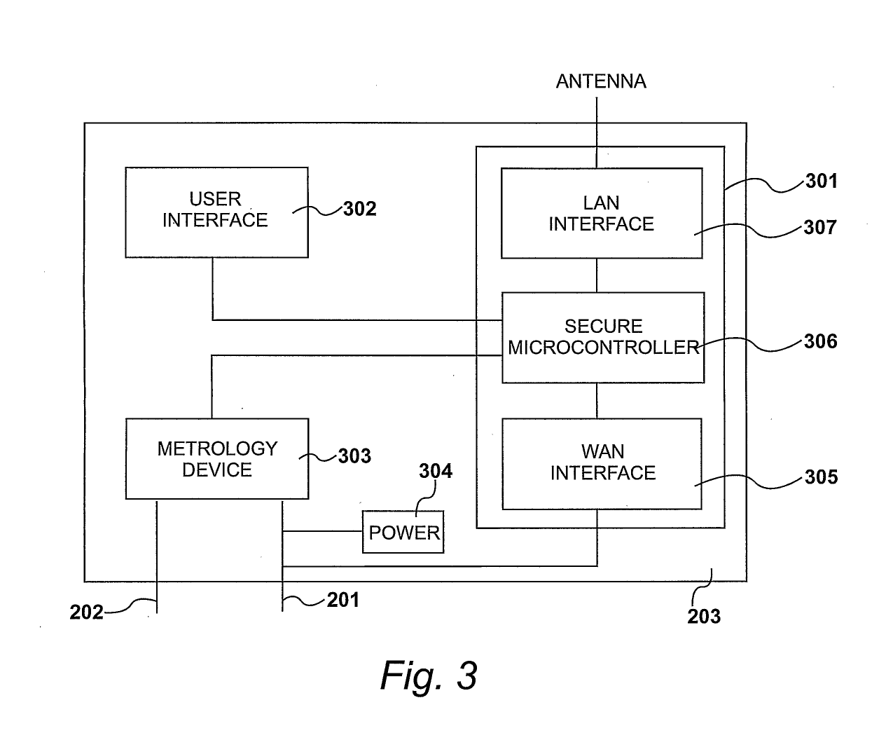

### FIG. 3

Meter 203 is detailed in FIG. 3. It includes a communications block 301, a user interface 302, a metrology device 303 and a power supply unit 304. Communications block 301 comprises a Wide Area Network (WAN) interface 305, a secure microcontroller 306 and a Local Area Network (LAN) interface 307. Secure microcontroller 306 is connected to each of the other elements of the meter.

Metrology device 303 connects between the incoming mains electricity 201 and the premises electricity wiring 202, and measures the electricity consumption within house 106. Information regarding electricity usage is displayed to a user on user interface 302. The power supply unit 304 provides a low voltage power supply for the electronics in the smart meter from the incoming power line 201.

In this embodiment, WAN interface 305 facilitates communication via power line 201. LAN interface 307 facilitate communication wirelessly, using a protocol such as ZigBee®. Thus any communication between one of the local devices and one of the servers is routed through microcontroller 306.

In this example the communications block 301 is implemented as a module or sub-system within the meter 203. The communications block 301 could also be implemented as a set of components soldered to the same printed circuit board as the other components of meter 203.

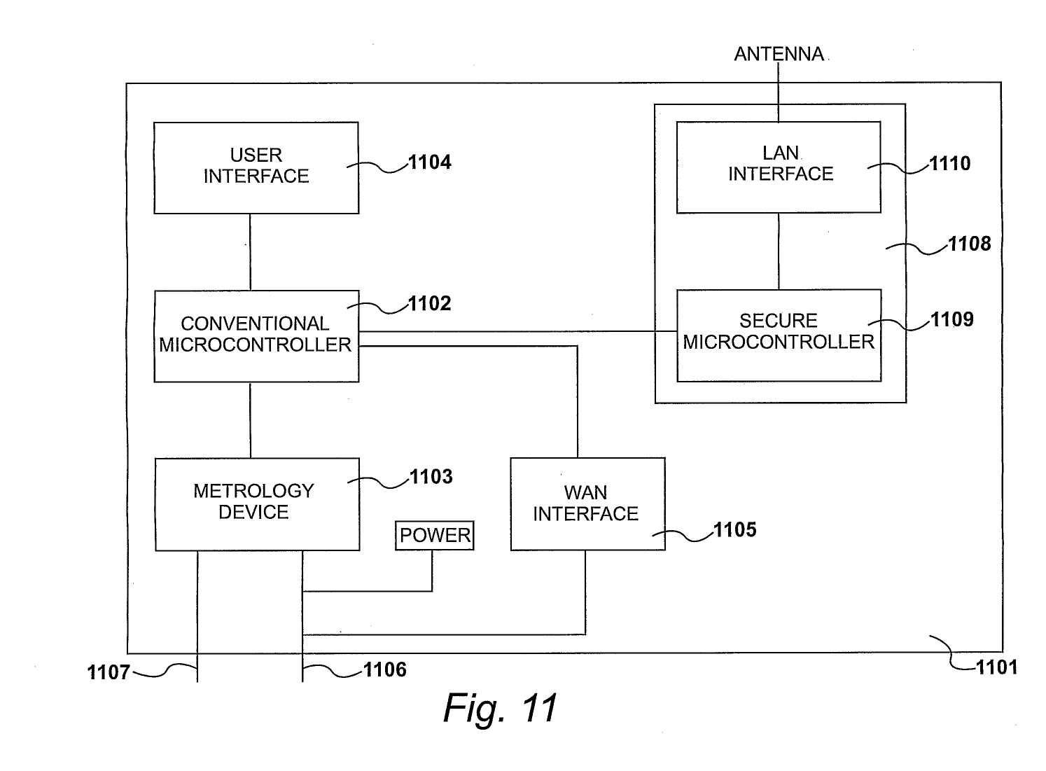

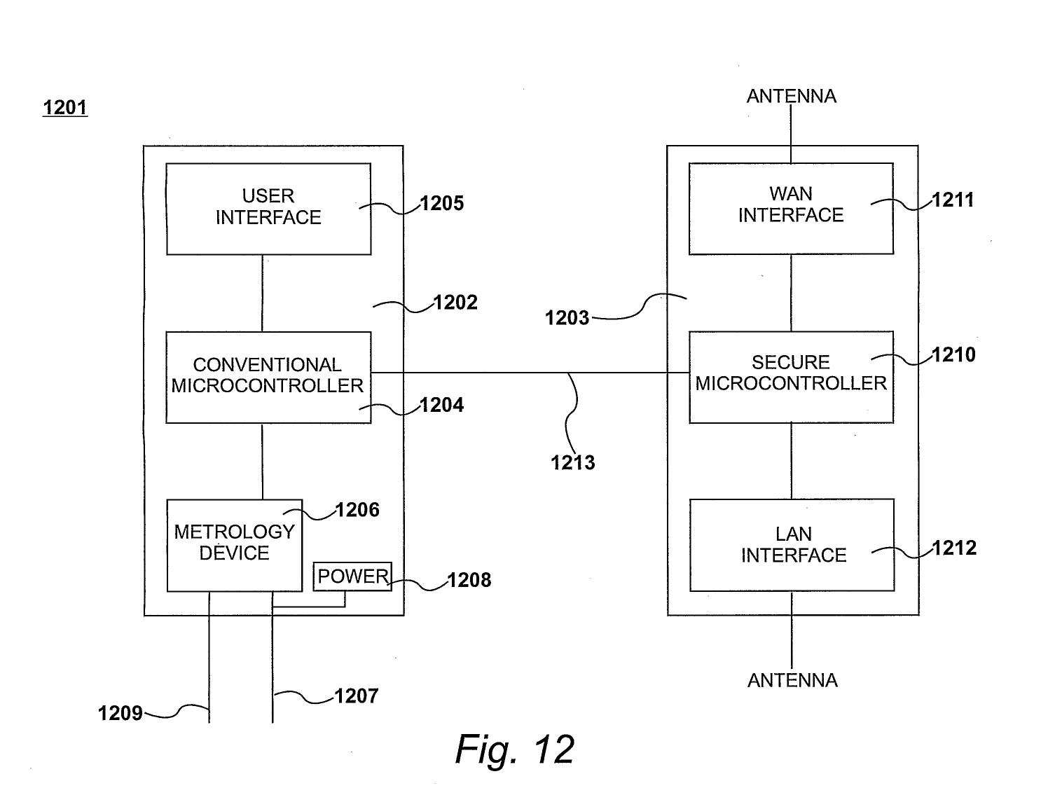

Although in this example meter 203 is an electricity meter, it could be a meter for any other utility, such as gas, water, heat, and so on. Further, many other embodiments of the meter are possible and these will be discussed with reference to FIGS. 11 and 12.

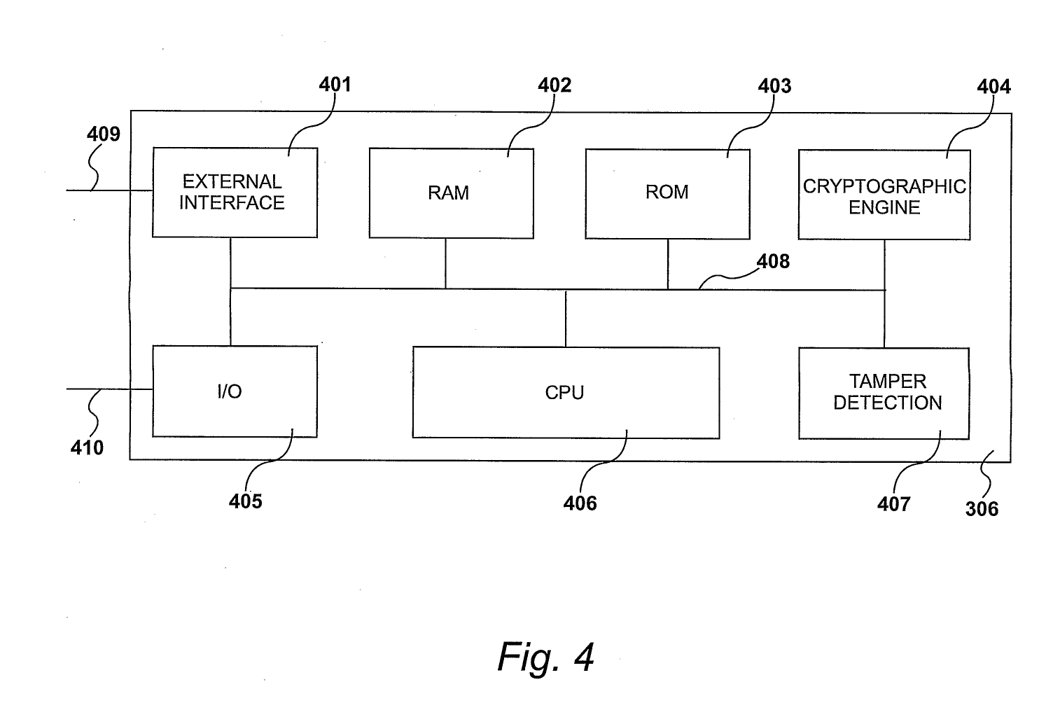

### FIG. 4

FIG. 4 is a block diagram of secure microcontroller 306. It is typically implemented as shown in FIG. 4, but it will be understood that there are many variations of microcontroller architectures that differ in some details from FIG. 4.

A processor provided by Central Processing Unit 406 connects through the internal bus 408 to RAM memory 402 which may be used to store data which typically changes frequently and to ROM memory 403 which may be used to store programs and data which typically change infrequently or not at all.

An external interface element 401 allows the microcontroller 306 to communicate with other external circuitry through external interface 409. Optionally one or more input-output elements 405 may exist and connect to other components through input-output interfaces 410.

Secure microcontroller 306 also includes a cryptography element 404 which is capable of performing calculations necessary for cryptography.

It also includes a tamper detection and prevention element 407 which is designed to detect and defeat attempts to compromise the operation of the secure microcontroller 306 by determined and skilled assailants. Such assailants might seek to read or modify the program and data stored within the RAM 402 or ROM 403. For example, if assailants were able to read cryptographic keys stored within a microcontroller they would be able to read or modify encrypted messages which the parties who were exchanging the encrypted messages had assumed were private. Furthermore, assailants might also be able to modify data or generate false messages such that the recipient of the data or messages incorrectly believed the data or messages to be accurate. Furthermore, assailants might then be able to manufacture counterfeit products.

Attacks on conventional microcontrollers are known to include operating the microcontroller at extremes of temperature or at extremes of power supply voltage or at extremes of clock frequency. Attacks also include exposing the microcontroller to electromagnetic fields and injecting pulses onto its external interface or input-output interfaces. Further attacks include power analysis, which can allow the internal operation of the microcontroller to be determined by monitoring the differences in power consumption that can occur as the microcontroller performs different internal operations.

The tamper detection and prevention element 407 present within the secure microcontroller provides protection against such attacks, which might be successful when deployed against a conventional microcontroller, thus preventing assailants from reading or modifying the programs and data contained within the RAM 402 or ROM 403.

Secure microcontrollers such as microcontroller 306 are frequently used in credit cards and smart cards and in mobile phone SIM cards. These are often referred to as Universal Integrated Circuit Cards (UICCs). Secure microcontrollers are also used in secure memory sticks and dongles used with personal computers and in trusted platform modules found in some computers.

In one implementation secure microcontrollers are used in credit cards and smart cards and in mobile phone SIM cards, where the microcontroller silicon chip is enclosed within a plastic card and where electrical connections are made to the card by exposed metal contacts in the face of the card. However secure microcontrollers can also take other forms, including the contactless card format in which the silicon chip is enclosed within a plastic card and where an coil of an electrically conductive material forms one part of a transformer which allows power to be supplied to the secure microcontroller and also allows for the exchange of messages with the secure microcontroller. In another implementation a secure microcontroller is packaged in a conventional integrated circuit package and is soldered to a printed circuit board. In yet another implementation a secure microcontroller is packaged in a conventional integrated circuit package and is soldered to a printed circuit board which makes up part of a module that plugs into a personal computer; USB memory sticks and dongles are examples of this implementation. Any implementation could be used as part of an embodiment of the invention described herein.

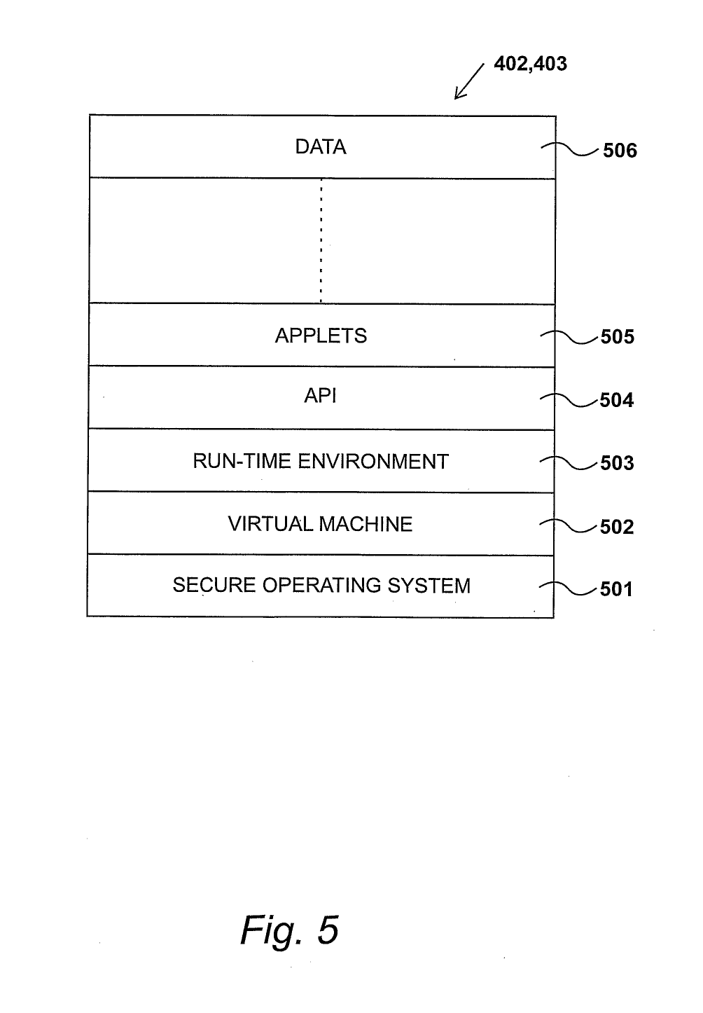

### FIG. 5

FIG. 5 illustrates the contents of the memory of secure microcontroller 306, embodied by RAM 402 and ROM 403. Programs in the memory, plus programs run by WAN interface 305 and LAN interface 307, control the exchange of messages through the WAN interface 305 with remote servers 101 to 104 and 118 and through the LAN interface 307 with local devices. In some implementations these programs merely act to route messages between a remote server and a local device. In other implementations the programs act to store, perform calculations on or otherwise process data received within messages received from the servers and the local devices.

Secure operating system 501 manages the hardware resources of secure microcontroller 306. Virtual machine 502 allows software written for the virtual machine to be executed on any secure microcontroller that implements the same virtual machine. A virtual machine is sometimes known as a byte code interpreter.

A number of programs, each comprising instructions and data, are also stored in the memory. In this example, these are applets 505, which are the application programs that run on secure microcontroller 306. Applets 505 can call upon standardised software functions implemented as the Application Programming Interface (API) 504. Run-time environment 503 is responsible for management of resources, communications and security of data and the exchange of data with applets 505.

Operating system 501, virtual machine 502, run-time environment 503 and API 504 are written by or on behalf of the manufacturer of secure microcontroller 306. These software elements do not change during the lifetime of the secure microcontroller 306. However, applets 505 are written by or on behalf of the manufacturer of the product which uses the secure microcontroller 306. Applets 505 define software that is specific to meter 203 and define its functionality.

The memory shown in FIG. 5 also includes data 506 used by the operating system 501, virtual machine 502, run-time environment 503 and API 504.

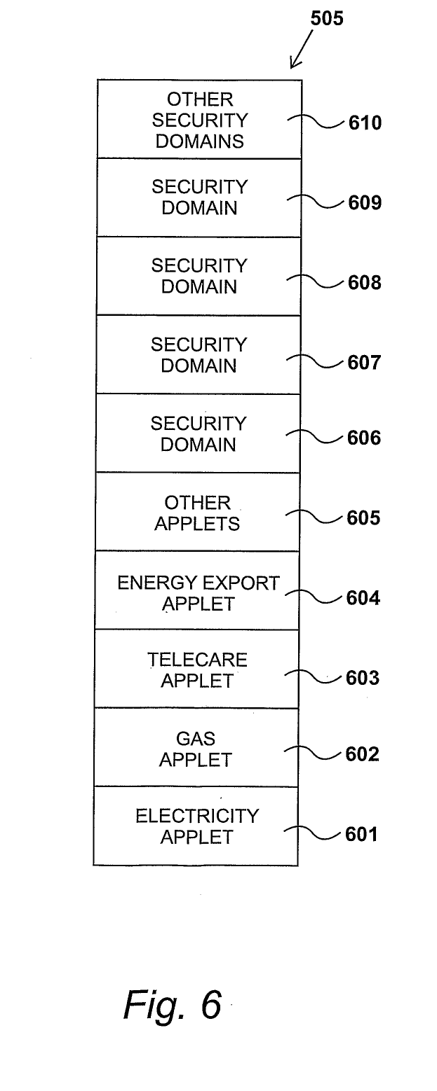

### FIG. 6

Applets 505 are further detailed in FIG. 6. Each of the local devices in house 106 is linked with one of the applets. Thus remote user interface 206 communicates with electricity applet 601, as does metrology device 303, which can be considered as a local device housed within meter 203. Gas meter 204 communicates with gas applet 602, while scales 207 and panic button 208 communicate with telecare applet 603. Transformer 210 communicates with energy export applet 604. All this communication occurs via LAN interface 307. Other applets 605 may also be present.

Some applets may also facilitate communication with a remote server, while others may only provide control, data storage or a user interface to a local device. Thus, applet 601 records continuous electricity consumption measurements from metrology device 303 and sends a daily summary of the electricity consumption to electricity supplier server 101, as well as alarm messages when anomalies are detected. The electricity supplier can also use applet 601 to permit easy payment of a bill, or to cut off the electricity if a bill has been unpaid. Applet 601 also sends information for display to remote user interface 206. Transformer 210 also communicates with electricity supplier server 101, but via electricity export applet 604. Gas meter 204 communicates with gas supplier server 102 via applet 602. Applet 603 accumulates daily weight measurements from the weighing scales 207 and sends a summary of the weight readings on a weekly schedule to telecare provider server 103. However, if panic button 208 is depressed, an immediate alarm is sent to server 103.

Thus many of the applets provide a secure communications channel between a local device and an associated server. This can be a direct channel, inasmuchas messages are routed directly from a device to a server or vice versa. However, it may also be an indirect channel, where information or messages from a remote device are stored, changed or accumulated and a different message is then sent to a server. A communications channel can therefore be considered to be simply the routing of information from one point to another point. An important aspect, however, is that messages, data, information and so on are not shared with any other applet, any other local device nor any other server, and thus the channel is secure.

Applets 501 may be managed remotely, even after meter 203 is installed, by an infrastructure management authority. Applets may be downloaded, installed, enabled or disabled or uninstalled by a computer program running external to the secure microcontroller 306. The applet management process is performed by run-time environment 503 and an off-card computer program running on infrastructure management authority server 118. By employing appropriate cryptographic protocols the applet management instructions sent by the off-card computer program can be verified by run-time environment 503, ensuring that only an authorised off-card computer program under the control of the infrastructure management authority can manage the deployment of applets 505.

The applet management process also provides a secure and reliable method of updating software on secure microcontroller 306 from one version to another version.

Each applet is mapped to an additional applet called a security domain. Thus applet 601 is mapped to security domain 606, applet 602 is mapped to security domain 607, applet 603 is mapped to security domain 608, and applet 604 is mapped to security domain 609. Other security domains 610 may be present. Each security domain carries out cryptographic operations for its corresponding applet. More than one applet may be mapped to a single security domain.

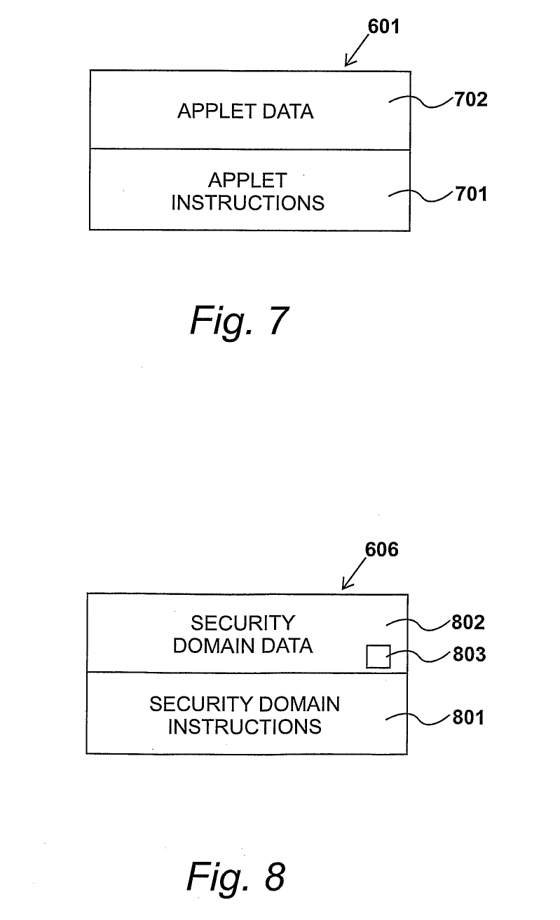

### FIGS. 7 and 8

This is detailed further in FIGS. 7 and 8. Applet 601 contains instructions 701 and data 702, while security domain 606 contains instructions 801 and data 802, which includes cryptographic keys 803. When applet 601 needs to communicate securely, either with a local device or with remote server 101, security domain 606 performs cryptographic operations using cryptographic keys 803 to ensure that the communication is secure and authenticated. Thus applet 601 does not have access to the cryptographic keys used for its own communications. Further, security domain 606 will not accept instructions from any other applet than applet 601.

The instructions 701 and data 702 associated with applet 601 are kept secret from all other applets. This security is enforced by the other software elements. Further, since each applet is associated with its own cryptographic keys, other applets are unable to decrypt applet 601's messages. This allows applet 601 and its associated off-card program running on its associated server to establish their own logical secure communications channel.

This allows several applets to co-exist on the same secure microcontroller, and preserves security even in the event that the applets are written by different software suppliers. Since microcontroller 306 cannot be tampered with, and since each applet cannot access other applets' instructions, data or communication channels, all communication between local devices, applets and remote servers is secure. This means that third parties can use meter 203 to facilitate communication between their own device and server without worrying about any other software that may be already installed or installed at a later date. Without this knowledge, all third parties would have to agree to more software installation, and complete trust would be necessary. This would be unlikely. For example, an electricity supplier would not trust a gas supplier not to analyse electricity usage in order to offer the consumer a better deal. Telecare providers would be unable to provide any service at all unless they could be sure that the data was kept confidential. Data protection laws generally mean that companies are under an obligation to keep certain consumer details secret, which is only possible when one program is guaranteed not to be able to access another program running on the same computer. The invention herein described provides such a guarantee.

It will be understood that the functions implemented by the secure microcontroller software described here can also be implemented by alternative approaches that use different software elements. Any software stack could be used that has a plurality of programs, each comprising instructions and data, as long as a processor can, using one of these programs, provide a secure communications channel between a local device and an associated server, wherein the processor is unable to accept commands from any other of said programs to access or change the program, nor route messages over said secure communications channel that are not from or to the local device and the associated server.

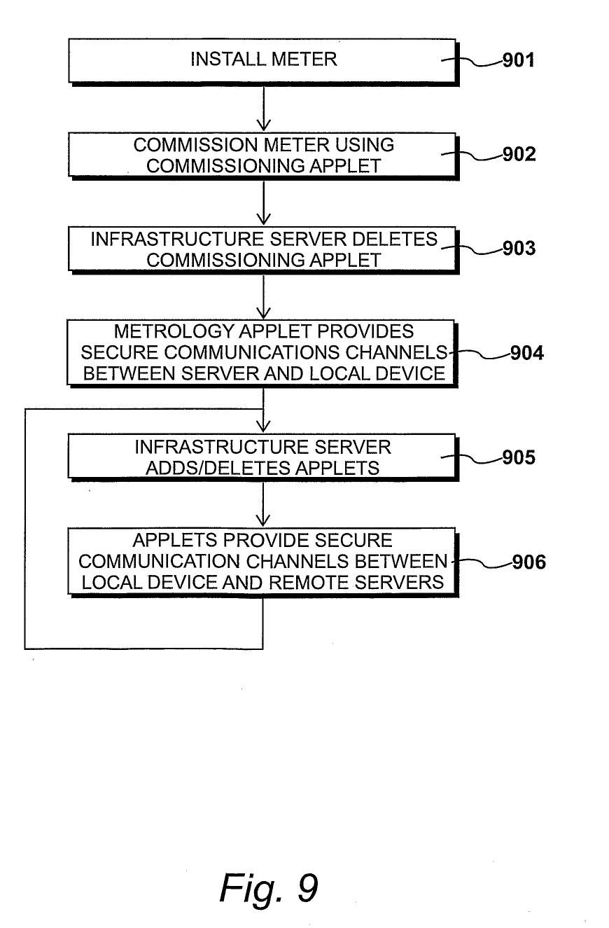

### FIG. 9

FIG. 9 shows operational steps for meter 203. At step 901 the meter is installed in home 106, and at step 902 it is commissioned by the engineer using a commissioning applet. Once the meter is commissioned, the commissioning applet is deleted by the infrastructure management authority under instructions from the electricity supplier at step 903.

At step 904 metrology applet 601 provides a secure communications channel between electricity supplier server 101, and metrology device 303 and remote user interface 206. This involves receiving consumption data from metrology device 303 and storing it, displaying consumption data on user interface 206, periodically sending consumption data to server 101, periodically receiving tariff data from server 101 and storing it, and displaying tariff data on remote user interface 206. The applet 601 may also perform other functions.

At step 905 the infrastructure management authority server adds or deletes other applets on behalf of third parties. These may be any sort of applet that communicates with any sort of server or local device. Usually these are installed remotely via internet 105 and mains power line 201. However, an applet could also be installed locally via a local interface. At step 906, all the installed applets provide secure communications channels between their respective local devices and servers. Following this, steps 905 and 906 are repeated with new applets being added, old applets being deleted and installed applets continuing to provide secure communication channels.

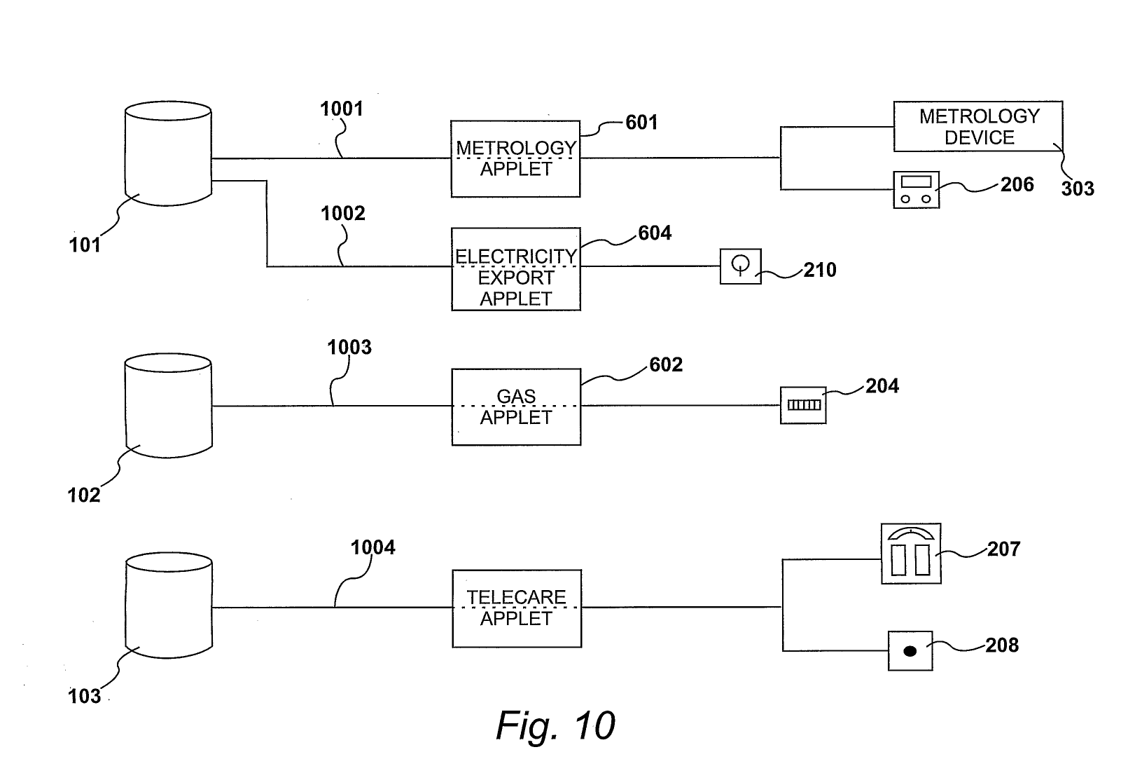

### FIG. 10

Secure communication between local devices and remote servers is illustrated in FIG. 10. Electricity supplier server 101 communicates with metrology device 303 and remote user interface 206. Metrology applet 601 within meter 203 communicates securely, via the shared platform provided by the other software within secure microcontroller 306 and LAN interface 307, with metrology device 303 and with remote user interface 206. Metrology applet 601 similarly communicates, via the shared platform provided by the other software within secure microcontroller 306 and WAN interface 305, with electricity supplier server 101. Thus a secure communications channel 1001 is provided between server 101 and local devices 303 and 206.

Similarly, electricity export applet 604 provides a secure communications channel 1002 between server 101 and transformer 210. Gas applet 602 provides a secure communications channel 1003 between gas supplier server 102 and gas meter 204. Telecare applet 603 provides a secure communications channel 1004 between telecare provider server 103, and scales 207 and panic button 208.

Many possible applets are envisaged. For example, a local device might be an expensive consumer item that communicates wirelessly with a geofencing applet on secure microcontroller 306. Regular communication confirms that the item is within range of the meter 203. However, if the item fails to communicate with the meter for a predetermined length of time it stops working, on the basis that it has been taken out of the home 106. Additionally, items equipped with an audible alert mechanism could be required to identify themselves by an applet.

A TV licence applet could be connected to a TV within the home. If the TV licence is not paid, the TV can be instructed to stop working. Other pay-per-use services could also be managed this way.

Various financial services applets could be provided that provide services to users. For example, the meter 203 could communicate with a credit-card reader as a local device. The credit-card reader could be a contact-type reader or a contactless reader using NFC communications. When the user makes a purchase online, the financial services applet could be used to verify the credit or debit card used. The user would insert the card and enter a PIN on the credit-card reader local device, which would display a one-time password for entry into the vendor's website. The applet would verify the PIN and perform the calculation of the password.

The meter could alternatively communicate with a full Chip-and-PIN terminal as a local device, allowing payment to be made by communication with a bank server, under the control of a financial services applet.

Pre-pay items could be topped up using the meter 203, for example a travel card or a mobile telephone. This could be done via user interface 302, or if the meter 203 included a Near-Field Communication (NFC) reader, then an NFC-enabled item could simply be touched to the meter. The NFC reader could alternatively be located in a remote device, such as remote user interface 206. An applet would then communicate with a relevant server to add credit to an account. Payment could be taken as described above, added to the electricity bill, or by some other method. The NFC reader is considered to be a local device whether it is located in the remote user interface 206 or the meter 203.

NFC tags could be supplied with wireless-enabled items, and touched to an NFC-enabled meter or NFC-enabled remote user interface to enable a commissioning applet to commission the item, allowing it to join the wireless network. If kept, the NFC tag could be used to commission the item to a new network when the owner moved house. This would provide an easy way of setting up communication between a meter and local devices.

A local device comprising storage, such as a hard drive, FLASH drive or other suitable means, could be used to allow other local devices to back up data, such as a mobile phone address book. Ana applet would control the storage of and access to such data. The storage device could be contained within the meter or remote from it.

A local device comprising a barcode reader or an RFID reader could be used to read barcodes or RFID tags on items bought from a supermarket. An applet would communicate with a server to identify the item and return the information to the user. This would be useful for a partially-sighted person. A similar applet could place an order for the item with the supermarket for home delivery. The reader device could be contained within the meter or remote from it.

Another applet could be used to allow communication between two users. For example, text messages, emails or images could be sent from one meter to another meter.

Other local devices that would usefully be connected to an applet on meter 203 in order to communicate with a remote server are a fire alarm, smoke alarm, movement sensors or burglar alarm. A building management applet could communicate with various sensors and actuators around home 106 in order to provide energy management.

If the bandwidth of the LAN interface 307 and WAN interface 305 were sufficient, an applet on meter 203 could be used to provide Internet connectivity to computers and other internet-connected devices in home 106.

### FIG. 11

An alternative embodiment of a smart meter that embodies the invention is shown in FIG. 11. Smart meter 1101 is installed in home 107 and has been retrofitted with the capability to implement the invention herein described. It includes a conventional microcontroller 1102 connected to a metrology device 1103, a user interface 1104 and a WAN interface 1105. WAN interface communicates with the concentrator at substation 109 via mains power line 1106. Premises electricity wiring 1107 provides electricity to devices within home 107.

These components alone provide what is currently known as a “smart meter”. Conventional microcontroller 1102 stores data from metrology device 1103 and sends it, via WAN interface 1105 and mains power line 1106, to electricity supplier server 101. Meter 1101 cannot, however, be used to embody the present invention because multiple programs cannot be installed on it that will provide secure communications channels between local devices and servers, nor even securely store data received from local devices.

Thus communications block 1108, comprising secure microcontroller 1109 and wireless LAN interface 1110, is added. Secure microcontroller 1109 is largely identical to secure microcontroller 306 and runs programs, including applets, in the same way. However, WAN communications are routed via conventional microcontroller 1102. Since the communications are already encrypted this does not impact on security.

Again, the WAN interface could be another type of interface, as could the LAN interface. Communications block 1108 could be implemented as an additional circuit board within the meter 1101, as a smart card that plugs into meter 1101, or as any other type of suitable add-on module internal or external to the meter 1101.

### FIG. 12

Another embodiment of the invention is shown in FIG. 12. Meter 1201 is contained within home 111. It includes a metrology block 1202 and a communications block 1203. Metrology block 1202 comprises a conventional microcontroller 1204 connected to a user interface 1205 and a metrology device 1206. Mains power line 1207 provides power to meter 1201 via power supply unit 1208. Premises electricity wiring provides power to home 111. Metrology block 1202 is equivalent to a prior art “non-smart” meter and simply measures power consumption and displays it to a user.

Communications block 1203 comprises a secure microcontroller 1210, a WAN interface 1211 and a LAN interface 1212. In this embodiment, both interface 1211 and interface 1212 are wireless. The LAN is in this example the ZigBee® network, while the WAN is a wireless mesh network radio suitable for radio communication with concentrator 115.

In this embodiment the communications block 1203 and the metrology block 1202 are housed in their own enclosures and communicate through connection 1213 using an Ethernet connection. However, any appropriate technology could be used, such as Universal Serial Bus (USB), an RS232 serial port, one of several wireless local area network technologies, and others.

Secure microcontroller 1210 is functionally identical to secure microcontroller 1109 and runs applets to provide secure communications channels to local devices within home 111 and remote servers.

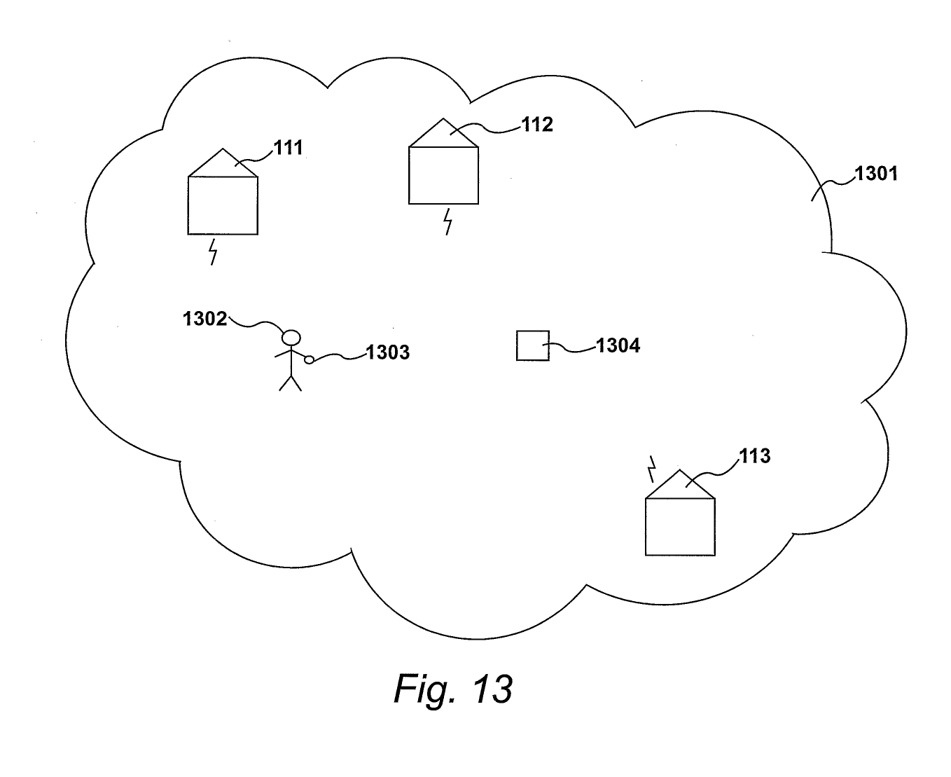

### FIG. 13

As discussed above, communication between the secure microcontrollers 306, 1109 and 1210 and their local devices is facilitated via a wireless network such as ZigBee®. Each microcontroller only communicates, via its respective LAN interface, with its own devices. However, each is also capable of communicating with other devices and with each other. This allows a Community Area Network (CAN) 1301 to be created. The CAN could have local hubs, or could be a “mesh network” involving peer-to-peer communication, as shown in FIG. 13. In a CAN, each meter or other device embodying the invention is considered to be a node, and each has one or more applets that carry out methods described below.

It has been discussed above with reference to FIG. 10 that local devices could be located or geofenced using applets on a meter. This principle also holds for devices within the CAN. A stolen device 1304 might require location, or a young or confused person 1302 could be equipped with a location device 1303 configured to communicate with any nearby node. These communications include received signal strength indication (RSSI) measurements, indicating signal strength and therefore distance from a node, and are stored for later consideration. If the person is missing, then a carer can, at their own node, send out a request for any nodes that have communicated with device 1303 to send details of these communications. Triangulation using the latest communications can then locate person 1302.

For a device to communicate with a node it usually needs associating with that node by commissioning. Local devices are generally only associated with their own meters. However, a request for association, whether successful or unsuccessful, is sufficient for this purpose.

This approach has issues for personal privacy. A solution is to ensure that the device does not broadcast its own unique device ID, but rather an random, frequently changing number to avoid tracking. Each association request from device 1303 contains encrypted information, in this case the device's unique ID and RSSI data, but appears to come from one of these numbers. The node rejects the request and stores it. The request can therefore be considered to be malformed, in that it includes a device ID unknown to the node. Other methods of malforming the request would also work.

Once person 1302 is noted as missing, an applet on the carer's meter sends cryptographic keys to the other nodes. Applets on these nodes attempt to decrypt data within rejected association requests using these keys. If decryption is successful, the information is returned to the carer's node, and device 1303 can be located. This prevents location of person 1302 by anyone who does not have access to the node associated with device 1303.

Some nodes in the CAN might be uncooperative, in that they do not have the correct applets installed. In this case, device 1303 can still collect location data since RSSI measurements are obtained from beacon frames transmitted by all nodes. This data could then be included in the next association request to a cooperative node.

Alternatively, device 1303 might simply collect RSSI information and not attempt to contact any node at all. When a carer wishes to locate person 1302, an applet on the carer's node sends out messages to nodes that are near to the presumed location of person 1302. They then broadcast an “are you there” message to the device's ID. If the device receives it, it can request to join the network and be admitted, then returning its RSSI data so that it can be located.

Other methods of estimating distance from nodes are possible, such as ultra-wide band and chirp-spread-spectrum.

It would also be useful to allow a local device to associate itself with another node. For example, the user of weighing scales 207 might want to associate it with the node at a friend's house while visiting. In this example, the device 207 can be commissioned onto the LAN at the friend's house, for example by pressing buttons or using NFC tags. Further, a vulnerable person possessing a telecare device that informs the telecare provider of a fall will want to use it while out of the house as well as in. In this case, the device must join the network immediately, without commissioning. Commissioning applets on another node would be programmed to allow particular sorts of devices to join the network, but care should be taken to avoid devices masquerading as these special devices being allowed to join. Cryptographic operations should be used to ensure the authenticity of the device.

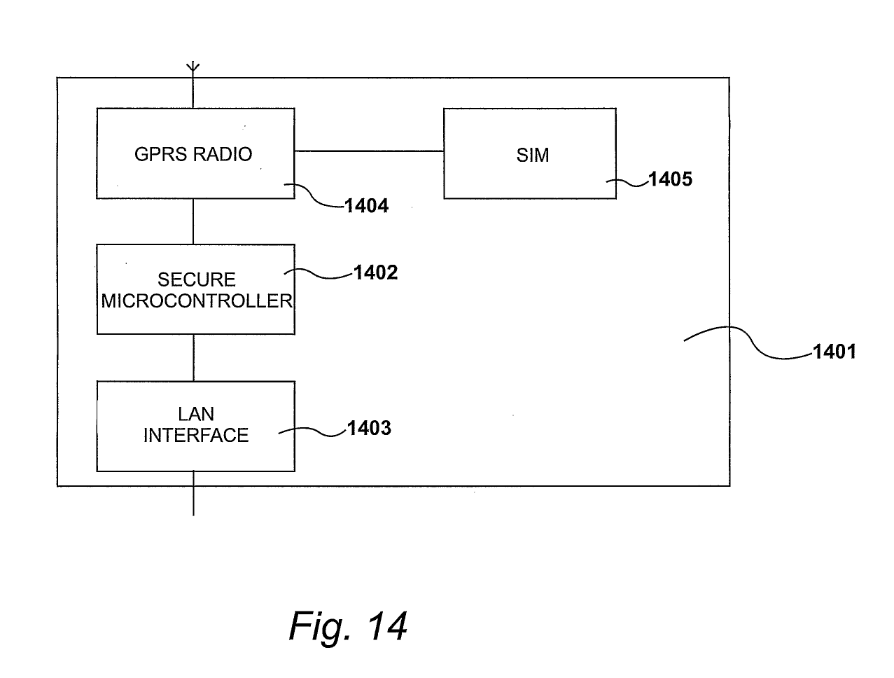

### FIG. 14

An example of another way of embodying the invention is shown in FIG. 14. Supermarket 119 contains a communications device 1401 which communicates with supermarket chain server 104. A secure microcontroller 1402, functionally similar to microcontroller 306, communicates with LAN interface 1403 and GPRS radio module 1404. Devices that monitor refrigerator temperatures are connected to LAN interface and are examples of local devices. A SIM card 1405 is connected to radio module 1404. Radio module 1404 and SIM card 1405 embody the WAN interface in this example, and GPRS radio module 1404 communicates through GPRS gateway 117. The function of SIM card 1405 is to take part in an authentication process with the GPRS radio network to identify the GPRS radio module 1404, to allow the GPRS radio 1404 and the GPRS network to authenticate each other, and to establish cryptographic keys to secure the wireless communications across the GPRS network. SIM card 1405 is itself a form of secure microcontroller.

A further embodiment is similar to device 1401, but without the SIM card. In this embodiment, the function of the SIM card is performed by the secure microcontroller. Therefore, the WAN interface comprises a GPRS radio and the secure microcontroller itself.

Communications device 1401 allows communication between refrigerator temperature sensors and server 104, under control of an applet that has been provided by the manufacturer of these sensors. However, because it embodies the present invention it is possible to install other applets and allow communication with other devices within the supermarket. For example, a lighting applet together with sensors that detect failing light bulbs could be installed within secure microcontroller. As another example, a heating, ventilating and air conditioning (HVAC) applet could be installed, and used to communicate with sensors and actuators in the HVAC equipment. Each of these applets could communicate with a single supemarket server 104, or with several servers each associated with one applet.

It can be understood that communications device 1401 facilitates communications between one or more servers, one or more applets and one or more sets of local devices in such a way that new services can be deployed in the communications device 1401 at any time. These new applets with their associated local devices and servers could be added in order to implement a new function. As new applets are added the operation of existing applets will not be disturbed by the new applet, and the data associated with each applet will be kept private.

Other examples of apparatus embodying the invention are an onboard computer in a car where each applet provides another facility such as navigation, insurance and road pricing, or a vending machine selling real or virtual products from multiple vendors. Any apparatus that facilitates secure communication, whether direct or indirect, between a local device and a remote server, and keeps local programs and data secure from each other and outside tampering would be appropriate.

1. Apparatus for facilitating communication between a plurality of servers and a plurality of local devices, comprising a first network interface for communicating with said servers, a second network interface for communicating with said local devices, and a microcontroller having a processor, memory, a cryptographic engine for carrying out cryptographic calculations, and a tamper-resistance element configured to resist tampering with said apparatus,
wherein a plurality of programs, each comprising instructions and data, are stored in said memory, and said processor is configured to:
for a first local device, identify a first program which is associated with said first local device, and
using said first program, provide a secure communications channel between said first local device and a first server, wherein
said processor is unable to accept commands from any other of said programs to access or change said first program, and
said processor is unable to route messages over said secure communications channel that are not from or to said first local device and said first server.

2. Apparatus according to claim 1, wherein said processor is configured to, when using said first program, process data received within, messages sent over said secure communications channel.

3. Apparatus according to claim 1, further comprising one of said local devices.

4. Apparatus according to claim 3, wherein said local device is a metrology device.

5. Apparatus according to claim 1, wherein said first network interface sends signals along a mains power line.

6. Apparatus according to claim 1, wherein said first network interface is a wireless interface.

7. Apparatus according to claim 1, wherein one of said programs provides connectivity for a telecare system.

8. Apparatus according to claim 1, wherein one of said programs configures said processor to disable a local device based on instructions from a server.

9. Apparatus according to claim 1, wherein one of said programs configures said processor to monitor a local device and inform a server if it is no longer within the local network.

10. Apparatus according to claim 1, wherein one of said programs provides connectivity for a financial service.

11. Apparatus according to claim 1, wherein one of said programs configures said processor to backup data stored on a local device to a remote server.

12. Apparatus according to claim 1, wherein one of said programs provides connectivity to increase the credit on a mobile telephone.

13. Apparatus according to claim 1, wherein one of said programs provides connectivity to increase the credit on a money-replacement card.

14. Apparatus according to claim 1, further comprising a barcode reader and a visual display, wherein one of said programs configures said processor to read a barcode on an item, obtain information associated with said barcode from a server, and output said information to said visual display.

15. Apparatus according to claim 1, further comprising a barcode reader, wherein one of said programs configures said processor to read a barcode on an item and place an order for a similar item on a server.

16. Apparatus according to claim 1, further comprising an RFID reader and a visual display, wherein one of said programs configures said processor to identify an RFID tag on an item, obtain information associated with said barcode from a server, and output said information to a visual display.

17. Apparatus according to claim 1, further comprising an RFID reader, wherein one of said programs configures said processor to identify an RFID tag on an item and place an order for a similar item on a server.

18. Apparatus according to claim 1, wherein one of said programs configures said processor to receive a message from a sensing device and send a message to a server to raise an alarm.

19. Apparatus according to claim 1, wherein said apparatus is further connected to a plurality of sensors, and one of said programs configures said processor to control local devices depending on signals received from said sensors.

20. Apparatus according to claim 1, wherein one of said programs configures said processor to receive a manual input and send a signal to a local device requesting it to audibly identify itself.

21. Apparatus according to claim 1, wherein one of said programs configures said processor to communicate with local devices via power lines.

22. Apparatus according to any of claims 1 to 20, further comprising a short range wireless communication interface.

23. Apparatus according to claim 22, wherein one of said programs configures said processor to communicate with a local device comprising a second wireless communication interface.

24. Apparatus according to claim 1, wherein one of said programs configures said processor to communicate with a plurality of other apparatus.

25. A network including a plurality of nodes, wherein each of said nodes is an apparatus according to claim 24.

26. A method of locating a device within a network having a plurality of nodes, wherein said device has a unique identifier, comprising the steps of:
at said device, broadcasting a message that is malformed and that includes encrypted data representing said unique identifier and location data; at one of said nodes, receiving said message, rejecting it as being malformed, and recording it;
at said node, receiving a message including a cryptographic key;
attempting to decrypt said encrypted data; and
if said decryption is successful, using said location data to locate said device.

27. A method according to claim 26, wherein said message is malformed because it includes an invalid user identifier.

28. A method according to claim 26, wherein said device and said node communicate wirelessly, and said location data comprises data indicating a signal strength between said local device and said node.

29. A method according to claim 26, wherein the location data stored at a plurality of nodes for said device is combined to locate said device.

30. A method of locating a device within a network having a plurality of nodes, wherein said device has a unique identifier, comprising the steps of:
at said device, storing a plurality of location data, wherein each of said location data indicates a location with respect to one of said nodes;
at one of said nodes, receiving a message including said unique identifier;
at said node, broadcasting a signal to said unique identifier, receiving a reply from said device and receiving said location data from said device.
